(19) United States
(12) Patent Application Publication
(10) Pub. No.: US 2023/0198869 A1
(43) Pub. Date: Jun. 22, 2023

(54) CUSTOMER PROBLEM REPORTING

(71) Applicant: T-Mobile Innovations LLC, Overland Park, KS (US)

(72) Inventors: Anbalagan Elumalai, Issaquah, WA (US); Daniel David Curry, Bothell, WA (US); Luis Alberto Uribe Gonzalez, Parsippany, NJ (US); Sergio Hernandez Mejorada, Chatsworth, CA (US)

(21) Appl. No.: 17/559,739

(22) Filed: Dec. 22, 2021

(51) Int. Cl. H04L 41/5074; H04W 4/029; H04W 24/04; H04W 24/10

(52) U.S. Cl. CPC H04L 41/5074; H04W 4/029; H04W 24/04; H04W 24/10

(57) ABSTRACT

Systems and methods for generating an auto-submission of a network incident of a telecommunications network include a user device including an incident interface and a cell site communicatively coupled to service management circuitry and the user device. The service management circuitry is structured to receive an indication of a network incident, incident data, and user device data associated with the user device, determine an occurrence of a network incident based on the indication of the network incident, the incident data, and the user device data, determine a location of the user device corresponding to the network incident, based on the network incident and the location of the user device, generate an auto-submission of the network incident in real-time or near real-time, and provide the auto-submission of the network incident generated to the issue data circuitry of the telecommunications network.

### SUMMARY

The present disclosure is directed, in part, to generating an auto-submission of a network incident of a telecommunications network, substantially as shown in and/or described in connection with at least one of the figures, and as set forth more completely in the claims.

In aspects set forth herein, a user device is connected to a telecommunication network. Typically, a customer experiences an incident (e.g., a call drop) while utilizing a user device. The customer then reports the incident by calling or texting an agent of a carrier. However, here, service management circuitry receives an indication of a network incident, incident data, and user device data associated with the user device and generates an auto-submission of the network incident in real-time or near real-time which removes the agent engagement to address the occurrence of the network incident and prioritizes a solution based on the location and/or severity of the network impact.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts an example of a network environment in accordance with one or more embodiments;

FIG. 2 is a diagram of a network environment including service management circuitry in accordance with an example embodiment;

FIG. 3 depicts a flowchart of an exemplary method for generating an auto-submission of a network incident of a telecommunications network in accordance with an example embodiment; and

FIG. 4 depicts an exemplary computing device suitable for use in implementations of aspects herein.

### DETAILED DESCRIPTION

The subject matter of embodiments of the invention is described with specificity herein to meet statutory requirements. However, the description itself is not intended to limit the scope of this patent. The claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

In certain aspects, methods are provided for generating an auto-submission of a network incident of a telecommunications network. An indication of a network incident, incident data, and user device data associated with the user device is received. An occurrence of a network incident is determined based on the indication of the network incident, the incident data, and the user device data. A location of the user device corresponding to the network incident is determined. An auto-submission of the network incident is generated in real-time or near real-time based on the network incident and the location of the user device. The service management circuitry is structured to provide the auto-submission of the network incident generated to the issue data circuitry of the telecommunications network.

Advantageously, generating an auto-submission of a network incident of a telecommunications network removes agent engagement to address the occurrence of the network incident, enables an informed diagnosis of the network incident, and prioritizes a solution and/or repair based on the location or severity of the network impact.

In one aspect, a method is provided for generating an auto-submission of a network incident of a telecommunications network. The method includes receiving, via a user device including an incident interface, an indication of a network incident, incident data, and user device data associated with the user device. The user device is associated with service management circuitry communicatively coupled to a telecommunications network. The method also includes determining an occurrence of a network incident based on the indication of the network incident, the incident data, and the user device data. The method also includes determining a location of the user device corresponding to the network incident. The method further includes, based on the network incident and the location of the user device, generating an auto-submission of the network incident in real-time or near real-time. The service management circuitry is structured to provide the auto-submission of the network incident generated to the issue data circuitry of the telecommunications network.

In another aspect, a computer-readable storage media having computer-executable instructions embodied thereon is provided that, when executed by one or more processors, cause the processors to perform various steps. The processors are caused to receive, via a user device including an incident interface, an indication of a network incident, incident data, and user device data associated with the user device. The user device is associated with service management circuitry communicatively coupled to a telecommunications network. The processors are also caused to determine an occurrence of a network incident based on the indication of the network incident, the incident data, and the user device data. The processors are also caused to determine a location of the user device corresponding to the network incident. The processors are further caused to generate an auto-submission of the network incident in real-time or near real-time based on the network incident and the location of the user device. The processors are further caused to prioritize one or more network incidents based on the auto-submission of the network incident.

In yet another aspect, a system is provided for generating an auto-submission of a network incident of a telecommunications network. The system includes a user device including an incident interface and a cell site communicatively coupled to service management circuitry and the user device. The service management circuitry receives an indication of a network incident, incident data, and user device data associated with the user device. The service management circuitry also determines an occurrence of a network incident based on the indication of the network incident, the incident data, and the user device data. The service management circuitry also determines a location of the user device corresponding to the network incident. The service management circuitry further generates an auto-submission of the network incident in real-time or near real-time generates based on the network incident and the location of the user device. The service management circuitry further provides the auto-submission of the network incident generated to the issue data circuitry of the telecommunications network.

Throughout this disclosure, several acronyms and shorthand notations are used to aid the understanding of certain concepts pertaining to the associated system and methods. These acronyms and shorthand notations are intended to help provide an easy methodology of communicating the ideas expressed herein and are not meant to limit the scope of aspects herein.

Embodiments herein may be embodied as, among other things: a method, system, or set of instructions embodied on one or more computer-readable media. Computer-readable media may include both volatile and nonvolatile media, non-transitory and transitory media, removable and non-removable media, and contemplate media readable by a database, a switch, and various other network devices. Computer-readable media includes media implemented in any way for storing information. Examples of stored information include computer-useable instructions, data structures, programmatic circuitry, and other data representations. Media examples include RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. Embodiments may take the form of a hardware embodiment, or an embodiment combining software and hardware. Some embodiments may take the form of a computer-program product that includes computer-useable or computer-executable instructions embodied on one or more computer-readable media.

“Computer-readable media” may be any available media and may include volatile and nonvolatile media, non-transitory media, as well as removable and non-removable media. By way of example, and not limitation, computer-readable media may include computer storage media and communication media.

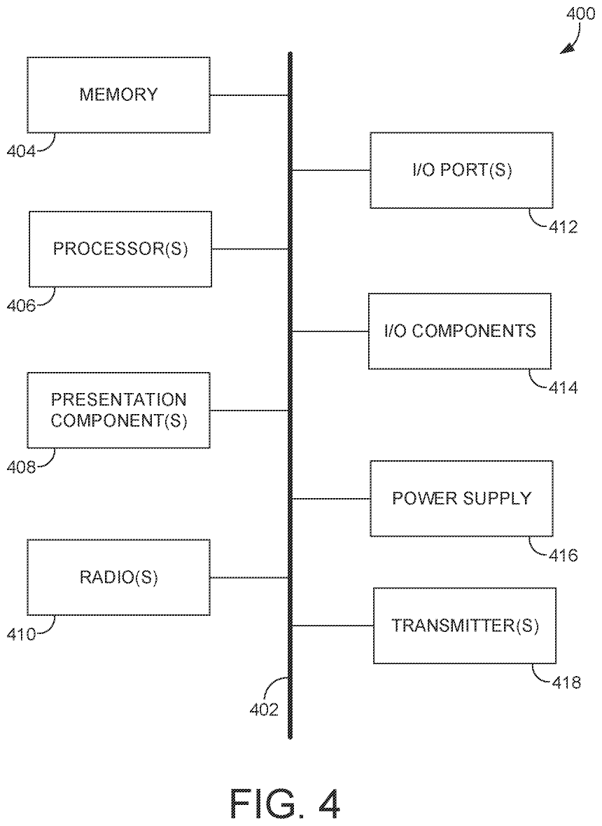

“Computer storage media” may include, without limitation, volatile and nonvolatile media, as well as removable and non-removable media, implemented in any method or technology for storage of information, such as computer-readable instructions, data structures, program circuitry, or other data. In this regard, computer storage media may include, but is not limited to, Random Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage devices, or any other medium which may be used to store the desired information and which may be accessed by the computing device 400 shown in FIG. 4. Computer storage media does not comprise a signal per se.

“Communication media” may include, without limitation, computer-readable instructions, data structures, program circuitry, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

The terms “user equipment,” “UE,” and “user device” are used interchangeably to refer to a device employed by an end-user that communicates using a network. UE generally includes one or more antenna coupled to a radio for exchanging (e.g., transmitting and receiving) transmissions with a nearby base station, via an antenna array of the base station. In embodiments, the UE may take on any variety of devices, such as a personal computer, laptop computer, tablet, netbook, mobile phone, smart phone, personal digital assistant, wearable device, augmented reality device, fitness tracker, or any other device capable of communicating using one or more resources of the network. The UE may include components such as software and hardware, a processor, a memory, a display component, a power supply or power source, a speaker, a touch-input component, a keyboard, and the like. In embodiments, some of the UE discussed herein may include current UE capable of using 5G or 6G and having backward compatibility with prior access technologies, current UE capable of using 5G or 6G and lacking backward compatibility with prior access technologies, and legacy UE that is not capable of using 5G or 6G.

A “network” refers to a network comprised of wireless and wired components that provide wireless communications service coverage to one or more UE. The network may comprise one or more base stations, one or more cell sites (i.e., managed by a base station), one or more cell towers (i.e., having an antenna) associated with each base station or cell site, a gateway, a backhaul server that connects two or more base stations, a database, a power supply, sensors, and other components not discussed herein, in various embodiments.

The terms “base station” and “cell site” may be used interchangeably herein to refer to a defined wireless communications coverage area (e.g., a geographic area) serviced by a base station. It will be understood that one base station may control one cell site or alternatively, one base station may control multiple cell sites. As discussed herein, a base station is deployed in the network to control and facilitate, via one or more antenna arrays, the broadcast, transmission, synchronization, and receipt of one or more wireless signals in order to communicate with, verify, authenticate, and provide wireless communications service coverage to one or more UE that request to join and/or are connected to a network.

An “access point” may refer to hardware, software, devices, or other components at a base station, cell site, and/or cell tower having an antenna, an antenna array, a radio, a transceiver, and/or a controller. Generally, an access point may communicate directly with user equipment according to one or more access technologies (e.g., 3G, 4G, LTE, 5G, mMIMO) as discussed hereinafter.

The terms “radio,” “controller,” “antenna,” and “antenna array” are used interchangeably to refer to one or more software and hardware components that facilitate sending and receiving wireless radio-frequency signals, for example, based on instructions from a base station. A radio may be used to initiate and generate information that is then sent out through the antenna array, for example, where the radio and antenna array may be connected by one or more physical paths. Generally an antenna array comprises a plurality of individual antenna elements. The antennas discussed herein may be dipole antennas, having a length, for example, of ¼, ½, 1, or 1½ wavelength. The antennas may be monopole, loop, parabolic, traveling-wave, aperture, yagi-uda, conical spiral, helical, conical, radomes, horn, and/or apertures, or any combination thereof. The antennas may be capable of sending and receiving transmission via FD-MIMO, Massive MIMO, 2G, 3G, 4G, 5G, and/or 802.11 protocols and techniques.

Additionally, it will be understood that terms such as “first,” “second,” and “third” are used herein for the purposes of clarity in distinguishing between elements or features, but the terms are not used herein to import, imply, or otherwise limit the relevance, importance, quantity, technological functions, sequence, order, and/or operations of any element or feature unless specifically and explicitly stated as such.

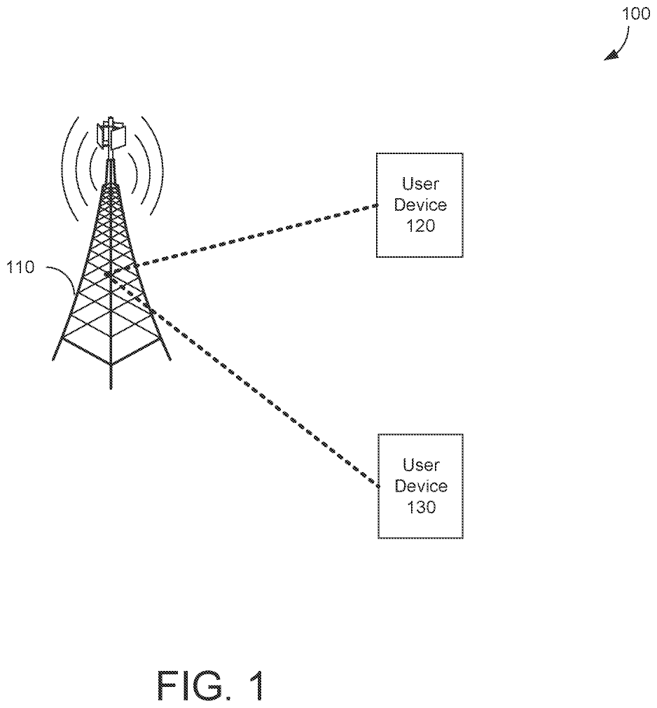

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

The network environment 100 provides service to one or more user devices 120 and 130. In some embodiments, the network environment 100 may include a telecom network (e.g., a telecommunication network such as, but not limited to, a wireless telecommunication network), or portion thereof. The network environment 100 may include one or more devices and components, such as base stations, servers, switches, relays, amplifiers, databases, nodes, etc. which are not shown so as to not confuse other aspects of the present disclosure. Those devices and components may provide connectivity in a variety of implementations. In addition the network environment 100 may be utilized in a variety of manners, such as a single network, multiple networks, or as a network of networks, but, ultimately, is shown as simplified as possible to avoid the risk of confusing other aspects of the present disclosure.

The telecom network included in the network environment 100 may include or otherwise may be accessible through a cell site (e.g., the cell site 110). The cell site may include one or more antennas, base transmitter stations, radios, transmitter/receivers, digital signal processors, control electronics, GPS equipment, power cabinets or power supply, base stations, charging stations, etc. such that the cell site may provide a communication link between one or more user devices (e.g., the user devices such as the user devices 120 and 130) and other components, systems, equipment, and/or devices of the network environment 100. The base station and/or a computing device (e.g., whether local or remote) associated with the base station may manage or otherwise control the operations of components of the cell site.

In some embodiments, the cell site may be operable in a non-stand alone (NSA) mode. In the non-stand alone mode the network environment 100 may take the form of, for example, an E-UTRAN New Radio-Dual Connectivity (EN-DC) network. In an EN-DC network, a user device may connect to or otherwise access a 4G, LTE, 5G, or any other suitable network. In the stand alone mode, the telecom network may take the form of a 5G, 6G, or any other suitable network.

In some embodiments, the network environment 100 may include one or more nodes communicatively coupled to one or more user devices such that the node(s) may transmit to and receive requests and/or data from the user device(s). The one or more nodes may include a Next Generation Node B (e.g., gNodeB or gNB) or any other suitable node. The one or more nodes may correspond to one or more frequency bands within which the user device(s) may connect to the network environment such as, but not limited to, a telecommunication network or a portion thereof.

In some embodiments, the node(s) may be included within the cell site (e.g., the cell site 110), external to the cell site, or otherwise communicatively coupled to the cell site. The node(s) may allocate radio frequency, or a portion thereof, to user device(s).

In some embodiments, the user device(s) may take the form of a wireless or mobile device capable of communication via the network environment 100. For example, the user device 120 may take the form of a mobile device capable of communication via a telecom network such as, but not limited to, a wireless telecommunication network. In this regard, the user device(s) may be any computing device that communicates by way of a network, for example, a 2G, 3G, 4G, LTE, WiMAX, Wi-Fi, 5G, 6G, or any other type of network.

In some embodiments, the network environment 100 may connect subscribers (e.g., current subscribers and/or potential subscribers) to a service provider or a plurality of service providers. Alternatively or additionally, the network environment 100 may be associated with a specific telecommunication provider or a plurality of telecommunication providers that provide services (e.g. 5G, 6G, voice, location, data, etc.) to one or more user devices. For example, the user devices 120 and 130 may be subscribers to a telecommunication service provider, in which the devices are registered or subscribed to receive voice and data services (e.g., receive content that may be streamed, downloaded, etc.) over the network environment 100. The network environment 100 may include any communication network providing voice and/or data service(s), such as, for example, a Wi-Fi network, 4G network (LTE, WiMAX, HSDPA), 5G network, or 6G network.

Having described the network environment 100 and components operating therein, it will be understood by those of ordinary skill in the art that the network environment 100 is but one example of a suitable network and is not intended to limit the scope of use or functionality of aspects described herein. Similarly, the network environment 100 should not be interpreted as imputing any dependency and/or any requirements with regard to each component and combination(s) of components illustrated in FIG. 1. It will be appreciated by those of ordinary skill in the art that the number, interactions, and physical location of components illustrated in FIG. 1 are examples, as other methods, hardware, software, components, and devices for establishing one or more communication links between the various components may be utilized in implementations of the present invention. It will be understood to those of ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1, it will be appreciated that some aspects may include a plurality of devices and/or components such that FIG. 1 should not be considered as limiting the quantity of any device and/or component.

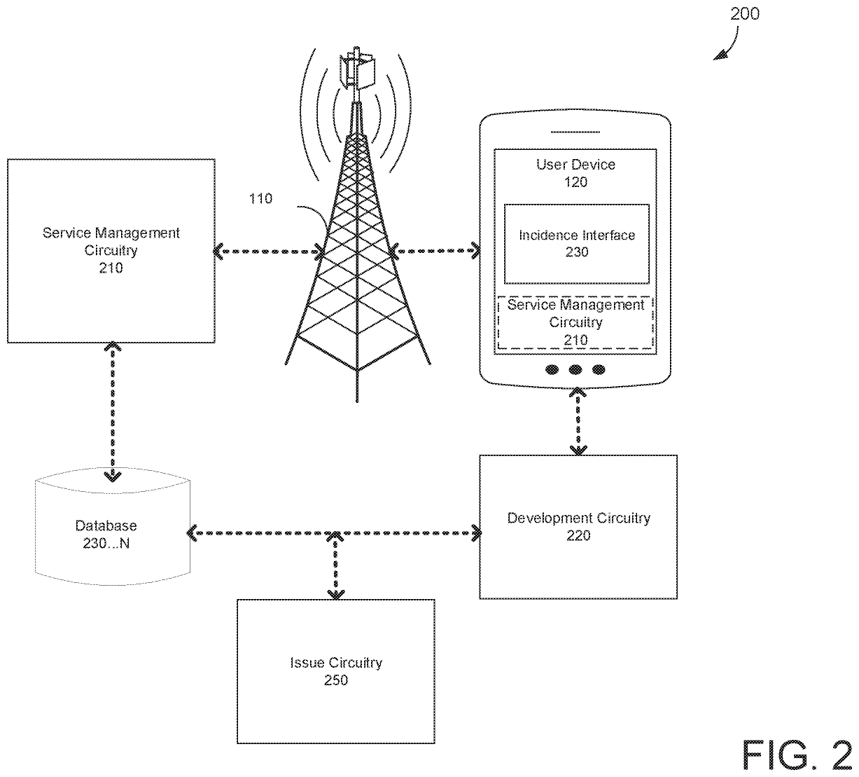

FIG. 2 is a diagram of the network environment 200 (e.g., a telecommunication environment such as, but not limited to, a wireless telecommunication environment) according to an example embodiment. In the present embodiment, the network environment 200 includes the cell site 110, user device 120, service management circuitry 210, development circuitry 220, database 230, and issue circuitry 250. Although some of the components in the network environment 200 are depicted as single components (e.g., a single service management circuitry, cell site, etc.), in some embodiments, the network environment 200 may include a plurality of such components. The service management circuitry 210 may be included within the cell site 110, external to the cell site 110, and/or otherwise communicatively coupled to the cell site 110 directly or indirectly. In some examples, the service management circuitry 210 may be included within the user device 120, external to the user device 120, and/or otherwise communicatively coupled to the user device 120 directly or indirectly.

In some embodiments, the service management circuitry (e.g., the service management circuitry 210) may receive an indication of a network incident. As used herein, the term “network incident” may be used to refer to an occurrence that impacts a telecommunications network such as, but not limited to, a signal loss, call drop, Internet speed decrease, and/or any other occurrence that impacts the network. In further embodiments, the service management circuitry may receive incident data and/or user device data associated with a user device (e.g., the user device 120). The user device data may include data associated with the user information, user behavior, device performance, device information, location of the user device, etc.

The service management circuitry may receive the indication of the network incident, incident data, and/or user device data via a user device that includes an incident interface (e.g., a user interface such as the incident interface 230). In some embodiments, the incident interface may include one or more images, buttons, radio buttons, drop downs, menus, fields, graphics, text buttons, message boxes, keypads, incident options, chat bots, and/or any other suitable component that facilitates the provision and/or receipt (e.g., collection) of data (e.g., input or any other information) corresponding to the network incident. In some examples, the service management circuitry may receive the user device data from a software development kit (SDK) via one or more API (Application Programming Interface) requests to send and/or receive data. Alternatively or additionally, the service management circuitry may receive the user device data from OEMs that provide data in response to a trigger. An example of a trigger may include a timeout caused due to non-receipt of an acknowledgement of receipt in response to transmission, by the user device, of a text message. Another example of a trigger may occur when the user device cannot detect one or more RF signals.

In some embodiments, one or more server logs of the user device may include the user device data. Alternatively or additionally, the server log(s) may include transactional data. In some embodiments, the service management circuitry may operate in an independent mode such that the service management circuitry may receive or otherwise retrieve data from one or more server logs independent of the telecommunications network 200 and/or cell site 110. For example, the service management circuitry 210 may collect data from the server log(s) of the user device 120 when the user device 120 is not communicatively coupled to the cell site 110 and/or the network 200.

In some embodiments, the service management circuitry may monitor a user experience corresponding to the user device. For example, if a call drops, the service management circuitry may look for the user device 120. In some examples, the service management circuitry may operate in an active mode or an inactive mode. In the active mode, the service management circuitry 210 may listen to, track, and/or monitor the data (e.g., the user device data, incident data, etc.) that is sent and/or received by the user device 120. In the inactive mode, the service management circuitry 210 may not listen to, track, and/or monitor the data that is sent and/or received by the user device 120.

In some embodiments, the service management circuitry may determine an occurrence of a network incident based on the indication of the network incident, the incident data, the user device data, or a combination thereof. In some examples, the network incident may be determined by the receipt of a network incident type included in the incident data. In further embodiments, the service management circuitry may determine an occurrence of a network incident based on the activity at the cell site(s). The service management circuitry may learn and/or analyze one or more network incidents. The network incident may be analyzed based on a single cell site or a plurality of cell sites. In some examples, the occurrence of the network incident may be determined by the derivation of the network type through machine learning that determines the network incident based on the aggregation of one or more network incidents. In further embodiments, one or more models may be trained according to training data to determine the occurrence of the network incident. The training data may cause the model(s) to generate predictions from data such as, but not limited to, incident data, and/or user device data. The machine learning may be based on models such as decision trees, deep neural networks, artificial neural networks, support-vector networks, bayesian networks, or any other suitable model.

In some examples, the service management circuitry may determine a location of the user device corresponding to the network incident. The location of the user device may be determined based on longitude data and latitude data associated with the user device such that the service management circuitry may track the geolocation of the user device. Alternatively or additionally, the incident interface (e.g., the incident interface 230) may render or otherwise display one or more outputs (e.g., signal strength, signal measurement type(s), and/or any other suitable measurement) the telecommunications network may be predicted to deliver on one or more access technologies (e.g., 3G, 4G, LTE, 5G, WiFi, etc.) at the location of the user device.

In some examples, the service management circuitry (e.g., the service management circuitry 210) may generate an auto-submission of the network incident. The auto-submission of the network incident may be generated in real-time or near real-time based on the network incident and the location of the user device. The service management circuitry may be structured to determine a network impact based on the auto-submission of the network incident. In further embodiments, the service management circuitry may be structured to provide the auto-submission of the network incident generated to issue data circuitry (e.g., the customer problem reporting data circuitry) of the telecommunications network.

In some embodiments, the service management circuitry may prioritize one or more network incidents based on the auto-submission of the network incident. For example, the service management circuitry may prioritize the network incidents such as, but not limited to, the loss of a signal as first priority, a dropped voice call as second priority, an outgoing SMS failure as third priority, slow 5G data as fourth priority, and slow LTE data as fifth priority.

Advantageously, generating the auto-submission of the network incident of a telecommunications network quickly reports a problem with minimum interaction while monitoring user experience(s) in real time. Additionally, the generation of the auto-submission of the network incident reduces the Mean Time to Resolution (MTTR) of network or device issues impacting the customer experience by removing agent engagement to address the occurrence of the network incident, enabling an informed diagnosis of the network incident, and/or prioritizing a solution based on the location or severity of the network impact.

In some embodiments, the service management circuitry may provide an issue notification (e.g., a notification that indicates the network incident has been received) to one or more user devices. The user device(s), via one or more incident interfaces, may output, render, or otherwise display the issue notification.

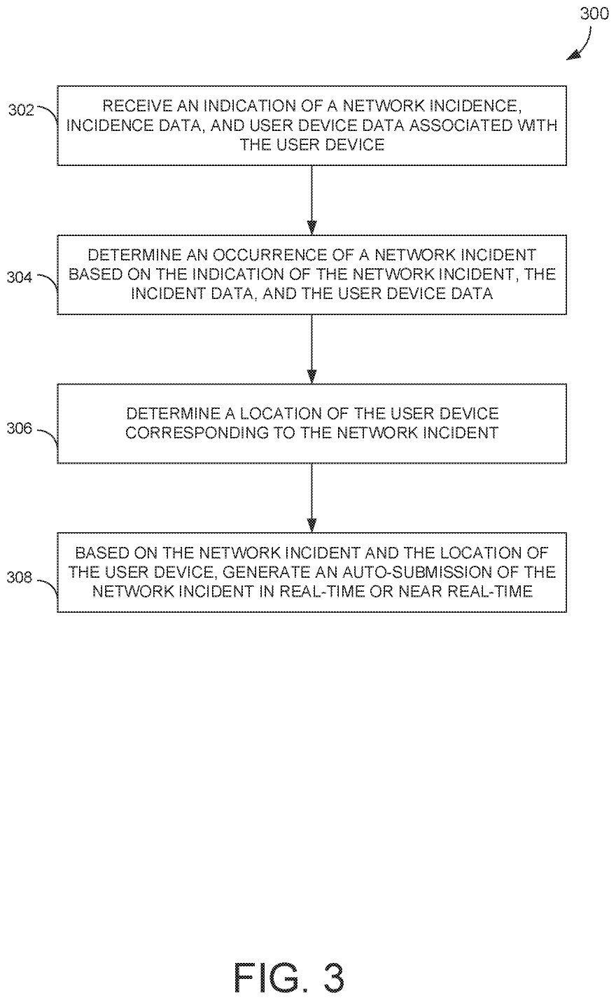

FIG. 3 depicts a flow diagram of an exemplary method 300 for generating an auto-submission of a network incident of a telecommunications network, in accordance with implementations of the present disclosure. Initially at block 302 an indication of a network incident is received by the service management circuitry. The service management circuitry may receive incident data and/or user device data (e.g., data associated with the user information, user behavior, device performance, device information) associated with a user device. The service management circuitry may receive, via an incident interface of the user device, the indication of the network incident, incident data, and/or user device data. The incident interface may include one or more buttons, radio buttons, drop downs, menus, fields, message boxes, incident options, chat bots, and/or any other suitable component that facilitates the provision and/or receipt of data (e.g., input or any other information) corresponding to the network incident.

At block 304, an occurrence of a network incident is determined based on the indication of the network incident, the incident data, the user device data. In this regard, the service management circuitry may learn and/or analyze one or more network incidents through machine learning based on the aggregation of one or more network incidents. Training data may cause one or more models to generate predictions from data such as, but not limited to, the incident data, and/or user device data.

A location of the user device corresponding to the network incident is determined at 306. The location of the user device may be determined based on longitude data and latitude data of the user device. In some embodiments, the service management circuitry may track the geolocation of the user device.

In some embodiments, an auto-submission of the network incident is generated based on the network incident and the location of the user device in real-time or near real-time at block 308. In some examples, the service management circuitry may be structured to provide the auto-submission of the network incident generated to the issue data circuitry of the telecommunications network.

Referring to FIG. 4, a block diagram of an example of a computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. In aspects, the computing device 400 may be a base station. In another embodiment, the computing device 400 may be UE capable of two-way wireless communications with an access point. Some non-limiting examples of the computing device 400 include a base station, a controller at a base station, a backhaul server, a personal computer, a cell phone, current UE, legacy UE, a tablet, a pager, a personal electronic device, a wearable electronic device, an activity tracker, a laptop, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 402 that directly or indirectly couples various components together. The bus 402 may directly or indirectly one or more of memory 404, processor(s) 406, presentation component(s) 408 (if applicable), radio(s) 410, input/output (I/O) port(s) 412, input/output (I/O) component(s) 414, power supply 416, and/or transmitter(s) 418. Although the components of FIG. 4 are shown with lines for the sake of clarity, in reality, delineating various components is not so clear, and metaphorically, the lines would more accurately be grey and fuzzy. For example, one may consider a presentation component(s) 408 such as a display device to be one of I/O components 414. Also, the processor(s) 406 may include memory 404, in another example. The present disclosure hereof recognizes that such is the nature of the art, and reiterates that FIG. 4 is merely illustrative of an example of a computing device 400 that may be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 404 may take the form of memory components described herein. Thus, further elaboration will not be provided here, but it should be noted that memory 404 may include any type of tangible medium that is capable of storing information, such as a database or data store. A database or data store may be any collection of records, files, or information encoded as electronic data and stored in memory 404, for example. In one embodiment, memory 404 may include a set of embodied computer-readable and executable instructions that, when executed, facilitate various functions or elements disclosed herein. These embodied instructions will variously be referred to as “instructions” or an “application” for short.

Processor(s) 406 may be multiple processors that receive instructions and process them accordingly. Presentation component(s) 408, if available, may include a display device, an audio device such as a speaker, and/or other components that may present information through visual (e.g., a display, a screen, a lamp (LED), a graphical user interface (GUI), and/or even lighted keyboards), auditory, and/or other tactile or sensory cues.

Radio(s) 410 represents one or more radios that facilitate communication with a wireless telecommunication network. For example, radio(s) 410 may be connected to one or more antenna elements through a physical path. Illustrative wireless telecommunications technologies include CDMA, GPRS, TDMA, GSM, and the like. Radio(s) 410 might additionally or alternatively facilitate other types of wireless communications including Wi-Fi, WiMAX, 3G, 4G, LTE, mMIMO, 5G, 6G, NR, VoLTE, and/or other VoIP communications. As can be appreciated, in various embodiments, radio(s) 410 may be configured to concurrently support multiple technologies, as previously discussed herein. As such, each of many radio(s) 410 may be used to separately control portions of an antenna array, for example, where at least one portion utilizes a distinct technology relative to another portion in the same antenna array or at the same base station or cell site. A wireless telecommunication network might include an array of devices, which are not shown so as to not obscure more relevant aspects of the invention. Components such as a base station, a communications tower, or even access points (as well as other components) can provide wireless connectivity in some embodiments.

The input/output (I/O) ports 412 may take a variety of forms. Exemplary I/O ports 412 may include a USB jack, a stereo jack, an infrared port, a firewire port, other proprietary communications ports, and the like. Input/output (I/O) components 414 may comprise keyboards, microphones, speakers, touchscreens, and/or any other item usable to directly or indirectly input data into the computing device 400.

Power supply 416 may include batteries, fuel cells, and/or any other component that may act as a power source to supply power to the computing device 400 or to other network components, including through one or more electrical connections or couplings. Power supply 416 may be configured to selectively supply power to different components independently and/or concurrently.

Finally, regarding FIGS. 1 through 4, it will be understood by those of ordinary skill in the art that the environment(s), system(s), and/or methods(s) depicted are not intended to limit the scope of use or functionality of the present embodiments. Similarly, the environment(s), system(s), and/or methods(s) should not be interpreted as imputing any dependency and/or any requirements with regard to each component, each step, and combination(s) of components or step(s) illustrated therein. It will be appreciated by those having ordinary skill in the art that the connections illustrated the figures are contemplated to potentially include methods, hardware, software, and/or other devices for establishing a communications link between the components, devices, systems, and/or entities, as may be utilized in implementation of the present embodiments. As such, the absence of component(s) and/or steps(s) from the figures should be not be interpreted as limiting the present embodiments to exclude additional component(s) and/or combination(s) of components. Moreover, though devices and components in the figures may be represented as singular devices and/or components, it will be appreciated that some embodiments can include a plurality of devices and/or components such that the figures should not be considered as limiting the number of devices and/or components.

It is noted that aspects of the present invention are described herein with reference to block diagrams and flowchart illustrations. However, it should be understood that each block of the block diagrams and/or flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Additionally, as should be appreciated, various embodiments of the present disclosure described herein can also be implemented as methods, apparatus, systems, computing devices/entities, computing entities, and/or the like. As such, embodiments of the present disclosure can take the form of an apparatus, system, computing device, computing entity, and/or the like executing instructions stored on a computer-readable storage medium to perform certain steps or operations. However, embodiments of the present disclosure can also take the form of an entirely hardware embodiment performing certain steps or operations.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

1. A method for generating an auto-submission of a network incident of a telecommunications network, the method comprising:
receiving, via a user device comprising an incident interface, an indication of a network incident, incident data, and user device data associated with the user device, wherein the user device is associated with service management circuitry communicatively coupled to a telecommunications network;
determining an occurrence of a network incident based on the indication of the network incident, the incident data, and the user device data;
determining a location of the user device corresponding to the network incident; and
based on the network incident and the location of the user device, generating an auto-submission of the network incident in real-time, wherein the service management circuitry provides the auto-submission of the network incident generated to issue data circuitry of the telecommunications network.

2. The method of claim 1, wherein the network incident comprises at least one of a signal loss, call drop, or Internet speed decrease.

3. The method of claim 1, wherein the location of the user device is determined based on longitude data and latitude data associated with the user device.

4. The method of claim 1, wherein the incident interface comprises at least one of text button, message box, keypad, one or more selection buttons, or one or more incident options.

5. The method of claim 1, wherein the service management circuitry is structured to monitor a user experience corresponding to the user device.

6. The method of claim 1, wherein one or more server logs of the user device comprise the user device data.

7. The method of claim 1, wherein the service management circuitry is structured to determine a network impact based on the auto-submission of the network incident.

8. The method of claim 1, wherein the telecommunications network is operable based on at least one of a WiFi, 5G, LTE, 3G, or 2G network.

9. The method of claim 1, wherein the user device comprises the service management circuitry.

10. Non-transitory computer-readable storage media having computer-executable instructions embodied thereon that, when executed by one or more processors, cause the processors to:
receive, via a user device comprising an incident interface, an indication of a network incident, incident data, and user device data associated with the user device, wherein the user device is associated with service management circuitry communicatively coupled to a telecommunications network;
determine an occurrence of a network incident based on the indication of the network incident, the incident data, and the user device data;
determine a location of the user device corresponding to the network incident;
generate an auto-submission of the network incident in real-time based on the network incident and the location of the user device;
based on the auto-submission of the network incident, prioritize one or more network incidents; and
prioritize a solution to the one or more network incidents based on at least one of the location or a severity of a network impact of the network incident.

11. The non-transitory computer-readable storage media of claim 10, wherein the network incident comprises at least one of a signal loss, call drop, or Internet speed decrease.

12. The non-transitory computer-readable storage media of claim 10, wherein the location of the user device is determined based on longitude data and latitude data associated with the user device.

13. The non-transitory computer-readable storage media of claim 10, wherein the incident interface comprises at least one of text button, message box, keypad, one or more selection buttons, or one or more incident options.

14. The non-transitory computer-readable storage media of claim 10, wherein one or more server logs of the user device comprise the user device data.

15. The non-transitory computer-readable storage media of claim 10, wherein the service management circuitry is structured to determine a network impact based on the auto-submission of the network incident.

16. A system for generating an auto-submission of a network incident of a telecommunications network, the system comprising:
a cell site communicatively coupled to service management circuitry and a user device, the service management circuitry comprising one or more processors and one or more computer storage hardware devices storing computer-useable instructions that, when used by the one or more processors, cause the one or more processors to:
receive an indication of a network incident, incident data, and user device data associated with the user device;
determine an occurrence of a network incident based on the indication of the network incident, the incident data, and the user device data;
determine a location of the user device corresponding to the network incident;
based on the network incident and the location of the user device, generate an auto-submission of the network incident in real-time; and
provide the auto-submission of the network incident generated to the issue data circuitry of the telecommunications network.

17. The system of claim 16, wherein the network incident comprises at least one of a signal loss, call drop, or Internet speed decrease.

18. The system of claim 16, wherein the location of the user device is determined based on longitude data and latitude data associated with the user device.

19. The system of claim 16, wherein the user device comprises the service management circuitry.

20. The system of claim 16, wherein one or more server logs of the user device comprise the user device data.
